(19) United States
(12) Patent Application Publication
(10) Pub. No.: US 2011/0081290 A1
(43) Pub. Date: Apr. 7, 2011

(54) APPARATUS AND PROCESS FOR THE PRODUCTION OF HYDROGEN GAS

(76) Inventor: Lyle E. Carnegie, Edmonton (CA)

(21) Appl. No.: 12/707,105

(22) Filed: Feb. 17, 2010

(30) Foreign Application Priority Data
Oct. 7, 2009 (CA) 2683148

(51) Int. Cl. C01B 3/26; B01J 19/00; B01J 23/10; B01J 23/75; B01J 23/755; B01J 21/00; B01J 21/06; B01J 21/18; B01J 23/58; B23P 11/00

(52) U.S. Cl. 423/651; 422/198; 502/304; 502/325; 502/338; 502/258; 502/174; 502/343; 502/328; 29/428

(57) ABSTRACT

A gasifier for organic matter is provided in which a layer of ceramic balls function to both mill clinkers and catalyse hydrogen gas production. The ceramic balls comprise at least one catalyst suitable for lowering the activation energy of the various reactions involved in producing hydrogen gas. A process for production of a product gas comprising hydrogen is also provided.

### FIELD

This relates to a novel and effective manner of introducing a catalyst medium into a gasifier.

### BACKGROUND

Canadian Patent Application 2,432,202 (Carnegie) discloses a gasifier for the production of hydrogen gas having a layer of balls positioned across a grate, to protect the grate from excessive heat and to act as a ball-mill to break up any clinkers that are caused by fusion of the ash. The process of producing the hydrogen gas involves the steps of pyrolysis, combustion and gasification. Pyrolysis occurs as the organic matter heats up. Volatiles are released and char is produced. Combustion occurs as the volatile products and some of the char reacts with oxygen to form a resultant gas mixture comprising carbon dioxide and carbon monoxide. The heat produced during combustion is used in the subsequent gasification reaction. Gasification then occurs as the char reacts with carbon dioxide, oxygen and steam to produce a product gas that includes carbon monoxide, carbon dioxide and hydrogen. There are a number of chemical reactions involved in gasification, of which some require catalysis for efficient hydrogen gas production.

### SUMMARY

In one aspect, the present technology provides an improved gasifier. Inclusion of catalyst materials in the ceramic balls of the Carnegie gasifier increased hydrogen gas production from about 15% to at least about 40%. Suitable catalysts include cobalt, nickel, Raney-nickel, Ni/CeO2/Al2O3, cobalt-promoted nickel, chromium-promoted nickel, Rh/CeO2/SiO2, chromium-iron catalysts, nickel/olivine, K2CO3, ZnCl2, NiMgAl2O5, NiMgAl4O8 and NiMgAl1.24O3.86, NiAl2O4, and other catalysts as would be known to one skilled in the art.

In another aspect, the present technology provides a ceramic ball comprising catalyst for the production of a product gas comprising hydrogen, wherein the ceramic ball, in conjunction with other ceramic balls can function as a ball-mill.

In another aspect, the present technology provides a method of providing a catalyst in a gasifier.

In yet another aspect, the present technology provides a process for producing hydrogen gas in which a layer of ceramic balls has a dual function of milling ash, which may be in the form of clinkers, and catalysing hydrogen gas production.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a front elevation view, in section, of a gasifier for organic waste.

FIG. 2 is a side elevation view, in section, of the gasifier illustrated in FIG. 1.

FIG. 3 is a top plan view of the combustion air inlet of the gasifier illustrated in FIG. 1.

FIG. 4 is a side elevation view of the combustion air inlet and water inlet of the gasifier illustrated in FIG. 1.

FIG. 5 is a top plan view of the grate agitator of the gasifier illustrated in FIG. 1.

FIG. 6 is a side elevation view of the grate agitator illustrated in FIG. 5.

FIG. 7 is a front elevation view, in section, of the gasifier illustrated in FIG. 1.

### DETAILED DESCRIPTION

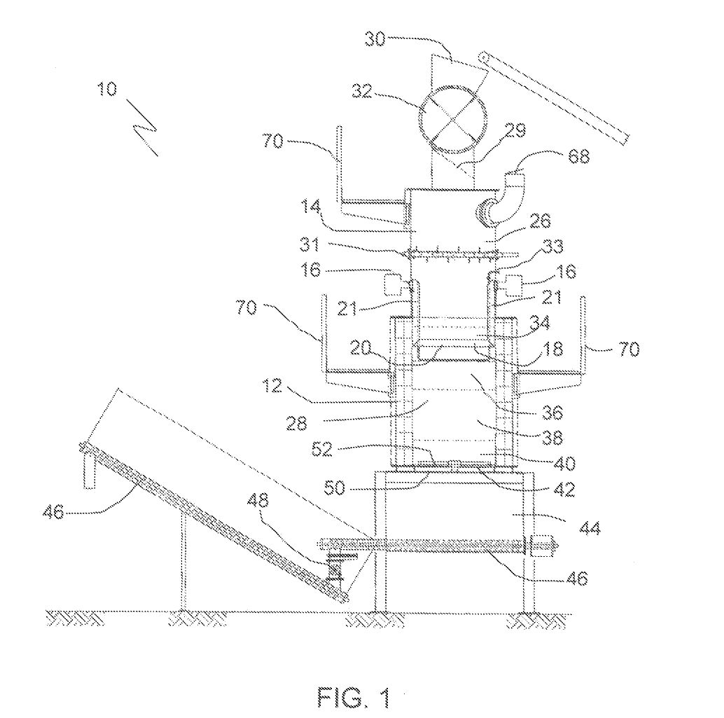

The preferred embodiment, a gasifier for organic matter generally identified by reference numeral 10, will now be described with reference to FIG. 1 through 7.

Structure and Relationship of Parts:

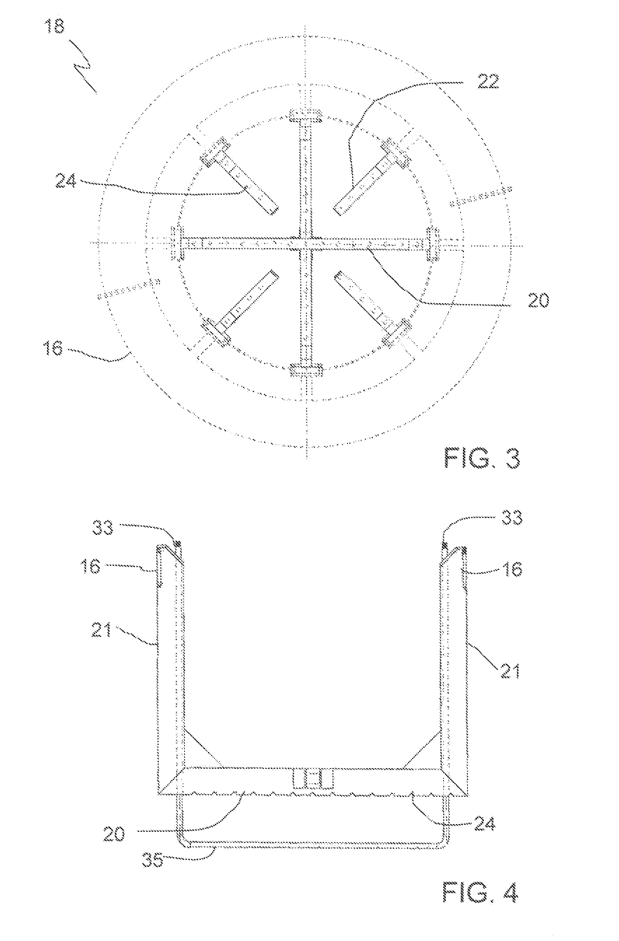

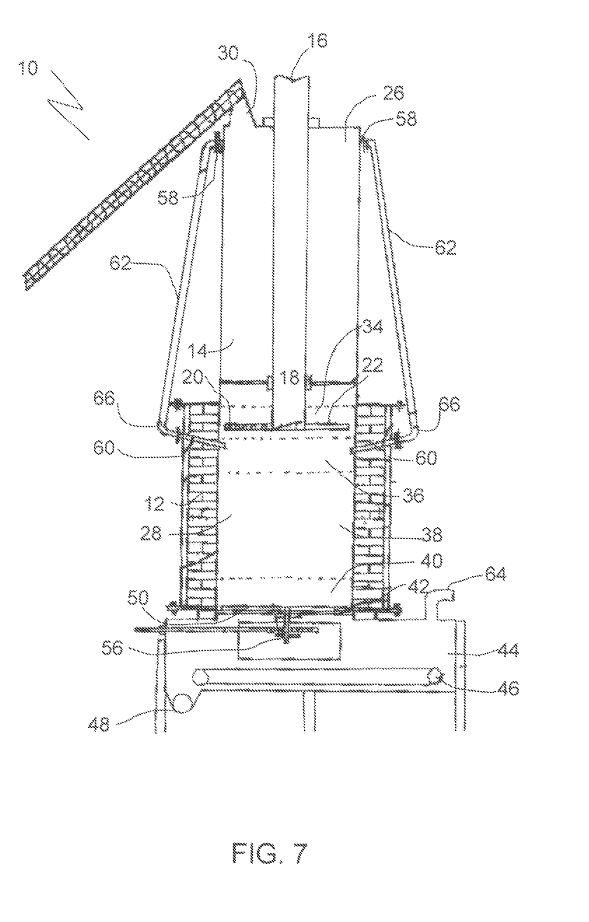

Referring to FIG. 1, there is illustrated a gasifier 10 which includes an insulated body 12 that has an interior cavity 14 which is lined with refractory material. An air inlet 16 extends into interior cavity 14 of body 12. As depicted, air manifold includes a series of conduits 21 projecting into interior cavity 14. Referring to FIG. 3, at a remote end 18 of combustion air inlet 16 is an air distributor 20 which has radially extending arms 22. Arms 22 are provided with outflow ports 24 for distributing air into interior cavity 14 illustrated in FIG. 1. Referring to FIGS. 3 and 4, outflow ports 24 are preferably located on the bottom of arms 22 to ensure combustion is directed downward. It will be understood that other designs for introducing air into interior cavity 14 may also be used aside from what is depicted, such as an air inlet that enters interior cavity 14 vertically, such as that shown in FIG. 7. Referring to FIG. 1, air distributor 20 serves to divide interior cavity 14 into an upper fuel receiving zone 26 and a lower combustion zone 28. A fuel entry port 30 accesses upper fuel receiving zone 26 of interior cavity 14, whereby organic waste to be gasified is introduced into upper fuel receiving zone 26. As shown, fuel entry port 30 includes a revolving door 32 as a feed hopper for introducing organic waste through fuel entry port 30. The revolving door 32 is protected by a heat shield 29. An upper agitator 31 may be provided below fuel entry port 30 to prevent fuel from becoming stuck. Lower combustion zone 28 includes a flame zone 34, a charcoal layer 36, a coal layer 38 and a layer of ceramic balls 40. A water injector 33 may be included to introduce water into charcoal layer 36. Water injector 33 may be used to reduce the temperature in combustion zone 28 and may also be used to raise the hydrogen gas content by providing additional water vapor to the gasification reaction Water is injected via a perforated pipe 35. Worker platforms 70 are attached to body 12 of gasifier 10 which allow workers access to different levels of the gasifier 10.

The ceramic balls contain at least one catalyst for reducing the activation energy required for hydrogen gas production. Suitable catalysts include cobalt, nickel, Raney-nickel, Ni/CeO2/Al2O3, cobalt-promoted nickel, chromium-promoted nickel, Rh/CeO2/SiO2, chromium-iron catalysts, nickel/olivine, K2CO3, ZnCl2, NiMgAl2O5, NiMgAl4O8 and NiMgAl1.24O3.86, NiAl2O4, and other catalysts as would be known to one skilled in the art. In the preferred embodiment, the catalyst is mixed with the ceramic during synthesis.

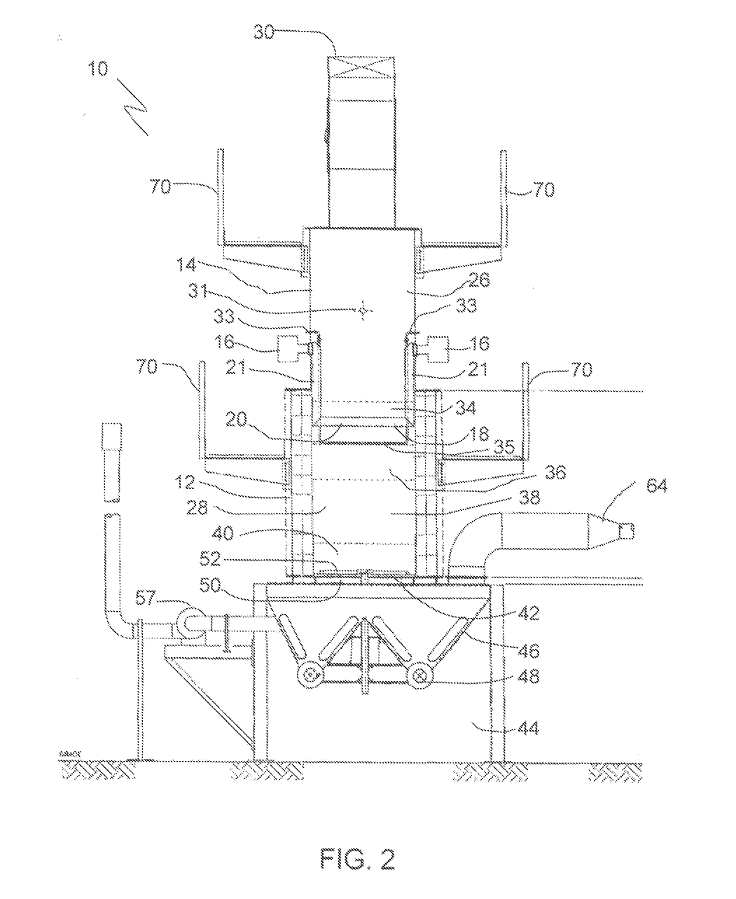

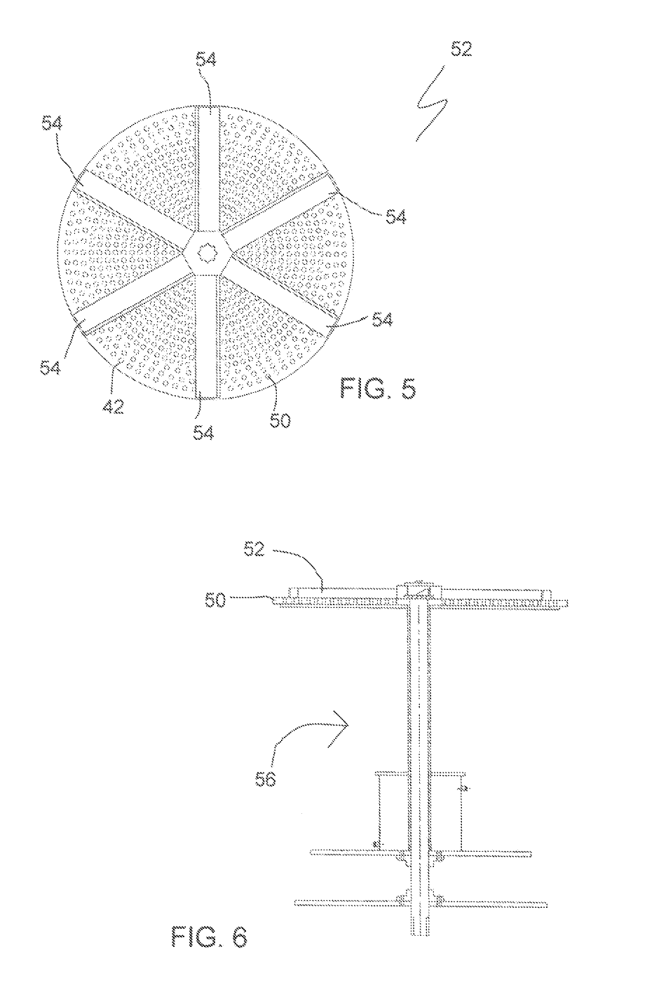

Referring to FIG. 1, an ash removal opening 42 accesses lower combustion zone 28 of interior cavity 14, whereby ash is removed after combustion. Referring to FIG. 2, in the illustrated embodiment, an ash box 44 is provided which has slatted conveyors 46 that sweep the ashes into augers 48. Referring to FIG. 5, a grate 50 is provided in ash removal opening 42. Referring to FIG. 1, a grate agitator 52 is positioned between layer of ceramic balls 40 and ash removal opening 42. Referring to FIG. 5, grate agitator 52 is equipped with triangular agitator blades 54. Referring to FIG. 6, grate agitator 52 is operated by an open type rack and pinion drive mechanism generally referenced by numeral 56. It is important that, among others, drive mechanism 56 and ask box 44 be sealed to prevent uncontrolled combustion air from entering gasifier 10. A shown in FIG. 1, a blower motor 57 is used to create negative pressure below combustion zone 28, which causes air to be drawn in through combustion air inlet 16.

Referring to FIG. 7, smoke removal ports 58 may be positioned in upper fuel receiving zone 26 of interior cavity 14 while smoke injection ports 60 are positioned in lower combustion zone 28 of interior cavity 14. Circulation conduits 62 connect smoke removal ports 58 with smoke injection ports 60, whereby smoke is drawn from upper fuel receiving zone 26 of interior cavity 14 and introduced into lower combustion zone 28 of interior cavity 14 to enhance combustion and promote circulation. Referring to FIG. 2, an outlet 64 from interior cavity 14 in provided for gases produced as a result of gasification of the organic waste through combustion.

Referring to FIG. 1, in the illustrated embodiment, gasifier 10 is of the sealed down-draft stratified type and can use any type of combustible raw material such as sawmill waste, railway ties, wood demolition material, rubber, oil refinery coke, coal, etc. It is a closed system and operates on a slight negative pressure so that there is no emission or noxious odors whatsoever.

Operation:

Referring to FIG. 1, raw organic waste material is loaded into upper fuel receiving zone 26 by feed auger 32 and is slightly stirred as combustion air inlet 16 slowly rotates. The organic waste material eventually works its way down to flame zone 34 in lower combustion zone 28 where the pyrolysis and combustion of the raw material takes place. About 10% of the raw material is used in this step and the remaining raw material is converted into charcoal, smoke, tars and water vapor. At this time the gasification process starts in charcoal layer 36.

As the material proceeds downward, charcoal layer 36 becomes white-hot coals within coal layer 38 which is also known as a cracking zone. As the gas is drawn off coal layer 38, the raw material is then completely used up and the remaining material is ash. Under coal layer 38, a layer of ceramic balls 40 serves to protect grate 50 from the excessive heat of coal layer 38, acts like a ball-mill to break up any clinkers that are caused by fusion of the ash and catalyses the production of hydrogen gas. Ceramic balls 40 are stirred by grate agitator 52 which is operated by open type rack and pinion drive mechanism 56. As ashes exit through ash removal opening 42 and collect in ash box 44, slatted conveyor 46 sweeps the ashes into auger 48 where the ashes are augured out of gasifier 10 for disposal.

Air is drawn down through combustion air inlet 16 and air distributor 20 by the negative pressure created by blower 57 into flame zone 34 where 20% oxygen may be added to the air stream to enhance combustion and also rid the gas of most of the nitrogen, which is drawn in with the atmospheric air. Referring to FIG. 3, the air and oxygen mixture exit combustion air inlet 16 through outflow port 24 in arms 22 of air distributor 20. Referring to FIG. 1, as the combustion air inlet 16 is slowly turning, it supplies air throughout flame zone 34 and insures complete bum in the entire flame zone 34. The heat of flame zone 34 is controlled by the amount of air and oxygen permitted to enter combustion air inlet 16. Once the oxygen in the mix is burned off combustion ceases and the remaining components of the air become inert.

Referring to FIG. 7, optional smoke circulation conduits 62 serve a dual function. They permit the smoke, vaporized tars and water vapor to be reintroduced into charcoal layer 36 below flame zone 34, which enhances the efficiency of flame zone 34. At a lower end 66 of smoke circulation conduits 62, the reaction of the smoke, tars and water vapor being cracked into gases creates a slight negative pressure which causes the vortex reaction in upper fuel receiving zone 26. Referring to FIG. 1, a blow out hatch 68 is provided on insulated body 12.

Referring FIG. 1, the draw on air into gasifier 10 is supplied by an outside source, for example a compressor or blower. With gasifier 10, the moisture content is not as critical as in an up-draft or cross-draft unit. The moisture content in the raw material can exceed 40% as the high heat (2300° F.) in the gasifier 10 cracks the water into hydrogen through what is called a water shift reaction. Additional reactions also lead to hydrogen gas production. The layer of ceramic balls 40 functions to increase the efficiency of the reactions leading to the production of hydrogen gas.

Gasifier 10 is not limited to one size. It can be scaled-up to units of differing sizes and can very easily be custom built to supply gas for co-generation of electrical power or as a single unit to replace natural gas, for example as in lumber drying kilns. It is understood that the three steps involved in producing hydrogen gas as outlined above are carried out in the gasifier.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

“Ball” refers to any suitable shape that allows sufficient rotation to permit ball-milling in the context of the present invention.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described. For example, the balls may be any shape and be configured in any manner that permits a dual function of acting as a ball-mill and providing a catalyst. For example, the balls may be egg-shaped, elongated, have a rough surface or a smooth surface, be pitted or have surface contour. The catalyst may be present in all the balls, or in a few balls. Further, the catalyst may be found uniformly throughout a given ball, or may be present only on the surface, or in a random mixture throughout the ball, as a coating, or as a partial covering. While the catalyst is preferably a non-precious metal, precious metals such as platinum, rhodium, palladium, ruthenium, and iridium are also contemplated.

What is claimed is:

1. A gasifier of organic matter, comprising:
an insulated body having an interior cavity;
a combustion air inlet extending into the interior cavity of the body, the combustion air inlet dividing the interior cavity into an upper fuel receiving zone and a lower combustion zone;
a fuel entry port accessing the upper fuel receiving zone of the interior cavity, whereby organic waste to be gasified is introduced into the upper fuel receiving zone;
an ash removal opening accessing the lower combustion zone of the interior cavity, whereby ash is removed after combustion;
a grate positioned in the ash removal opening;
a grate agitator adjacent to the grate for agitating the grate to facilitate the movement of ash through the grate;
an outlet from the interior cavity for gases produced as a result of gasification of the organic waste through combustion; and
a layer of ceramic balls positioned above the grate, the layer of ceramic balls thermally insulating the grate from excessive heat from the lower combustion portion of the interior cavity, the grate agitator agitating the ceramic balls, such that the ceramic balls serve as a ball-mill to break up clinkers formed by fusion of ash, characterized in that:
at least a portion of the ceramic balls include at least one catalyst selected for catalyzing hydrogen gas production.

2. The gasifier of claim 1 wherein the catalyst is selected from cobalt, nickel, Ni/CeO2/Al2O3, cobalt-promoted nickel, chromium-promoted nickel, Rh/CeO2/SiO2, chromium-iron catalysts, nickel/olivine, K2CO3, ZnCl2, NiMgAl2O5, NiMgAl4O8 and NiMgAl1.24O3.86, NiAl2O4 or combinations thereof.

3. The gasifier of claim 2, wherein the catalyst is cobalt or nickel.

4. A ceramic ball for use in gasification of organic matter for the production of hydrogen gas, the ceramic ball including at least one catalyst selected for catalyzing hydrogen gas production, such that in use, the ceramic ball provides catalyst and functions, in conjunction with other balls, as a ball-mill.

5. The ceramic ball of claim 4, wherein the catalyst is selected from cobalt, nickel, Ni/CeO2/Al2O3, cobalt-promoted nickel, chromium-promoted nickel, Rh/CeO2/SiO2, chromium-iron catalysts, nickel/olivine, K2CO3, ZnCl2, NiMgAl2O5, NiMgAl4O8 and NiMgAl1.24O3.86, NiAl2O4 or combinations thereof.

6. The ceramic ball of claim 5, wherein the catalyst is present throughout the ceramic ball.

7. The ceramic ball of claim 5, wherein the catalyst is present on at least a portion of the surface of the ceramic ball.

8. The gasifier of claim 1, further comprising:
smoke removal ports positioned in the upper fuel receiving zone of the interior cavity;
smoke injection ports positioned in the lower combustion zone of the interior cavity; and
smoke circulation conduits connecting the smoke removal ports with the smoke injection ports, whereby smoke is drawn from the upper fuel receiving zone of the interior cavity and introduced into the lower combustion zone of the interior cavity to enhance combustion and promote circulation.

9. A method of introducing catalyst in a gasifier, comprising:
positioning ceramic balls on an ash grate within the gasifier, the ceramic balls comprising a catalyst known to promote a gasification reaction producing hydrogen gas.

10. The method of claim 9, wherein the catalyst is selected from cobalt, nickel, Ni/CeO2/Al2O3, cobalt-promoted nickel, chromium-promoted nickel, Rh/CeO2/SiO2, chromium-iron catalysts, nickel/olivine, K2CO3, ZnCl2, NiMgAl2O5, NiMgAl4O8 and NiMgAl1.24O3.86, NiAl2O4 or combinations thereof.

11. The method of claim 10 wherein the catalyst is cobalt or nickel.

12. A gasifier of organic matter, comprising:
an insulated body having an interior cavity;
a combustion air inlet extending vertically into the interior cavity of the body, a remote end of the combustion air inlet serving to divide the interior cavity into an upper fuel receiving zone and a lower combustion zone;
a fuel entry port accessing the upper fuel receiving zone of the interior cavity, whereby organic waste to be gasified is introduced into the upper fuel receiving zone;
an ash removal opening accessing the lower combustion zone of the interior cavity, whereby ash is removed after combustion;
a grate positioned in the ash removal opening;
a grate agitator adjacent to the grate for agitating the grate to facilitate the movement of ash through the grate;
smoke removal ports positioned in the upper fuel receiving zone of the interior cavity;
smoke injection ports positioned in the lower combustion zone of the interior cavity;
smoke circulation conduits connecting the smoke removal ports with the smoke injection ports, whereby smoke is drawn from the upper fuel receiving zone of the interior cavity and introduced into the lower combustion zone of the interior cavity to enhance combustion and promote circulation;
an outlet from the interior cavity for gases produced as a result of gasification of the organic waste through combustion; and
a layer of ceramic balls positioned above the grate, wherein at least a portion of the ceramic balls include at least one catalyst selected for catalyzing hydrogen gas production and wherein the layer of ceramic balls thermally insulating the grate from excessive heat from the lower combustion zone of the interior cavity, the grate agitator agitating the ceramic balls, such that the ceramic balls serve as a ball-mill to break up clinkers formed by fusion of ash.

13. A process for producing a product gas, comprising hydrogen, in a gasifier, said process comprising:
(i) providing a layer of ceramic balls, the ceramic balls comprising a catalyst for the production of hydrogen gas;
(ii) providing organic matter;
(iii) heating the organic matter to produce a resultant gas mixture and ash;
(iv) both milling the ash and catalyzing production of the product gas by means of the layer of ceramic balls.

14. The process of claim 13, wherein the catalyst is selected from nickel and cobalt.
